(19) United States
(12) Patent Application Publication
(10) Pub. No.: US 2023/0119394 A1
(43) Pub. Date: Apr. 20, 2023

(54) POWER SUPPLY DEVICE AND METHOD FOR MANAGING SUCH A DEVICE

(71) Applicant: SAGEMCOM ENERGY & TELECOM SAS, Rueil Malmaison (FR)

(72) Inventors: Xavier FERRIERES, RUEIL MALMAISON (FR); Audrey SCHERPEREEL, RUEIL MALMAISON (FR)

(21) Appl. No.: 17/966,460

(22) Filed: Oct. 14, 2022

(30) Foreign Application Priority Data
Oct. 14, 2021 (FR) FR2110929

(51) Int. Cl. H02J 7/00; B60L 53/00; B60L 58/22

(52) U.S. Cl. CPC H02J 7/0016; H02J 7/0048; B60L 53/00; B60L 58/22; B60L 2200/12

(57) ABSTRACT

A power supply device comprising a group of at least one power supply cell, means for managing the cell group comprising a passive balancing unit of said cells, the device being wherein, during a request to move into long-duration storage mode of the device, the management means are configured to, via the passive balancing unit, discharge the cell group until the cell group reaches a target charge state or a target charge state range, if a charge state of the cell group is greater than the target charge state or the target charge state range.

The invention relates to a power supply device.

The invention also relates to a method for managing such a power supply device.

The invention also relates to a computer program associated with such a power supply device, as well as a medium for storing such a computer program.

### BACKGROUND OF THE INVENTION

For a few years, with the aim of reducing greenhouse gas emissions, more and more people travel by bike rather than a vehicle with a combustion engine (car, scooter, motorbike, etc.).

In order to be able to travel long distances more easily, lighter and more efficient electric bikes are being developed every day.

Naturally, the power supply device of an electric bike must be regularly recharged, said power supply device comprising cells (or batteries), progressively discharging.

It can occur that the owner of the electric bike only uses it for some of the year when the weather is nicer. If this owner stores their electric bike as such during winter, the extended storage of the electric bike can lead to a reduction of the service life of the cells.

### OBJECT OF THE INVENTION

An aim of the invention is to propose a power supply device making it possible to further preserve the service life of the cells of said device.

### SUMMARY OF THE INVENTION

In view of achieving this aim, a power supply device is proposed, comprising:

a group of at least one power supply cell, means for managing the cell group comprising a unit for passively balancing said cells.

According to the invention, during a request to move into long-duration storage mode of the device, the management means are configured to, via the passive balancing unit, discharge the cell group until the cell group reaches a target charge state or a target charge state range.

The invention consequently makes it possible to bring the cell group to a suitable charge state during a long-duration storage request. Indeed, the cell group is thus not stored fully charged, but at a predefined target charge state (or at a target charge state range). This makes it possible to better protect the cells and to preserve their service life.

The invention further proves to be simple in structure and implementation.

Advantageously, the invention has resorted to already-existing elements in retail, like in particular the passive balancing unit. Furthermore, it can be easily installed on power supply devices of the prior art.

Optionally, the management means comprise a BMS.

Optionally, the power supply device comprises a man-machine interface or is connected to a man-machine interface.

Optionally, the request to move into long-duration storage mode is transmitted to the device via the man-machine interface.

Optionally, the power supply device is a power supply device of an electric vehicle.

Optionally, the power supply device is a power supply device of an electric bike.

The invention also relates to a method for managing a power supply device which has just been described, comprising the step of, during a request to move into long-storage mode of the device, and if a charge state of the cell group is greater than the target charge state or the target charge state range, discharging the cell group until the cell group reaches the target charge state or the target charge state range.

Optionally, the management method comprises the step of, in the long-duration storage mode, charging the cell group, if a charge state of said cell group falls under a predetermined critical threshold.

The invention also relates to a computer program implementing the method which has just been described.

The invention also relates to a storage medium of the computer program which has just been described.

Other features and advantages of the invention will emerge upon reading the following description of particular, non-limiting embodiments of the invention.

### BRIEF DESCRIPTION OF THE DRAWINGS

The invention will be better understood in the light of the following description in reference to the accompanying figures, among which:

FIG. 1 schematically illustrates a power supply device according to a particular embodiment of the invention,

FIG. 2 is a flowchart illustrating a first example of an implementation of the device represented in FIG. 1,

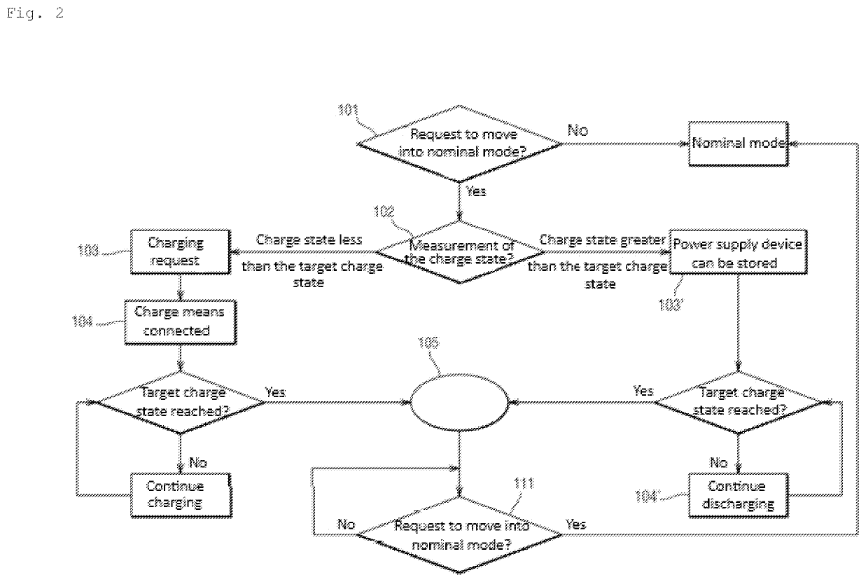

FIG. 3 is a flowchart illustrating a second example of an implementation of the device represented in FIG. 1.

### DETAILED DESCRIPTION OF THE INVENTION

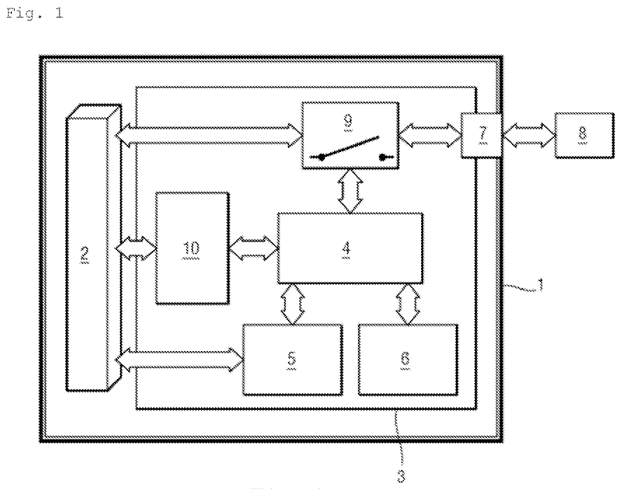

FIG. 1 illustrates a power supply device 1 according to a particular embodiment of the invention.

Such a power supply device 1 is intended to power an object, for example, a vehicle. Optionally, such a power supply device 1 is intended to power an electric bike.

In a manner known per se, the power supply device 1 comprises a group of at least one power supply cell and in this case, several power supply cells (also called power supply batteries), as well as means for managing said cells. The assembly formed by the cell group 2 and the management means 3 is sometimes also called “battery pack”. The cells are, for example, Lithium-type batteries, and for example, Lithium-Ion or Lithium-polymer-type batteries.

The management means 3 comprise, for example, an electronic board comprising a management member 4, of integrated circuit type, such as, for example, a microcontroller or a microprocessor. In the present case, the management means 3 comprise an electronic board including a microcontroller. Preferably, the electronic board comprises or is a “Battery Management System” (BMS).

Moreover, the management means 3 comprise measuring means 5 for the charge state of the cell group 2 (the charge state is sometimes more known as “State of Charge” or SoC). The measuring means 5 are incorporated to the management member 4 or are connected to the management member 4 such that the management member 4 can control them and thus estimate the charge state at an instant t of the cell group. The measuring means 5 comprise, for example, a sensor and/or a calculation member and determine the charge state of the cell group 2, for example:

by measuring and/or estimating a voltage at the terminals of the cell group 2, and/or by being based on data transmitted by a Coulombs meter associated with the cell group 2 and forming part of the power supply device 1.

In this case, it is noted that the measuring means 5 communicate the general charge state of the cell group 2 and not the charge state of each of the cells within said group.

Preferably, the power supply device 1 further comprises at least one man-machine interface 6 in connection with the management member 4 such that a user can interact with the power supply device 1 like, for example, giving them an order or collecting information about the power supply device 1. The man-machine interface 6 comprises, for example, at least one button and/or at least one light and/or at least one screen (touchscreen or not), etc.

Moreover, in order to be able to charge the power supply device 1 and in particular, the cell group 2, the power supply device 1 comprises a connection interface 7 to charge means 8 external to the power supply device. For example, the charge means 8 comprise or are a portable charger or a non-portable charger, or also an adapter connected to a mains plug, etc. The charge means 8 are naturally adapted to the connection interface 7. Particularly, it is, in this case, through this same connection interface 7 that the power supply device 1 is connected to the electric bike. Alternatively, the power supply device 1 can comprise a first connection interface for the connection to charge means external to the power supply device and a second connection interface for the connection to the electric bike.

The management means 3 thus comprise a circuit for transmitting an electric power between the connection interface 7 and the cell group 2.

Preferably, the management means 3 comprise a cut-off member 9 arranged on said circuit, the cut-off member 9 being connected to the management member 4. In this way, the management member 4 controls the cut-off member 9 to open (respectively close) the transmission circuit and thus refuse the charge of the cell group 2 (respectively enable the charge of the cell group). The cut-off member 9 is, for example, a switch such as a power switch, a contactor, etc.

The management means 4 also comprise a passive balancing unit 10 of the cell group 2. The management member 4 is connected to the passive balancing unit in order to control it.

In this case, it is reminded that for appliances using a battery pack, it is known that said pack integrates a unit for balancing the different cells, i.e. a unit which will make it possible to standardise the charge state of all the cells within the cell group. Indeed, in the long term, the different charge and discharge cycles of the battery pack can introduce a charge state imbalance between the different cells. The balancing unit therefore makes it possible to correct this imbalance.

To date, two types of balancing unit are known: the active balancing unit and the passive balancing unit.

The passive balancing unit makes it possible to standardise the charge state of the cells by forcing a discharge of the cells having higher charge state to bring them to the level of the cells having the lowest charge state.

To this end, the passive balancing unit is based, often on the principle of thermal dissipation to discharge the cells by Joule effect. The passive balancing unit comprises circuits integrating resistances arranged in parallel of the different cells, circuits which can be activated independently from one another. Moreover, the passive balancing unit comprises means for estimating the charge state of each of the cells. For example, these estimation means determine the charge state of each cell by measuring a voltage at the terminals of said cell.

When one of the cells has a charge state which is too high with respect to the others (which is determined by the estimation means), the passive balancing unit closes the corresponding parallel circuit: the associated cell thus discharges in the resistance of the parallel circuit which consequently heats up.

Because the different circuits can be activated independently, the passive balancing unit can thus only discharge one or more cells within the cell group. In the case of the present device, it is understood therefore that if the measuring means 5 only communicate the general charge state of the cell group 2, the passive balancing unit 10 makes it possible for it to estimate the charge state of each of the cells within said cell group 2 to ensure a balancing between the different cells.

In the case of the present device, in the nominal mode, the passive balancing unit 10 operates like in the prior art which has just been described, by selective discharge of one or more cells having higher charge state to bring them to the level of the cells having the lowest charge state. The general objective of the passive balancing unit 10 is naturally to align, to the maximum, the charge states of all the cells together (and preferably to the highest possible charge state).

Furthermore, the passive balancing unit 10 is also configured to be able to operate in a second so-called “long-duration storage mode” mode. In this long-duration storage mode, if this is requested of it by the management member 4, the passive balancing unit 10 is also configured to, if the charge state of the cell group 2 is greater than a target charge state, forcing the discharge of at least one of the cells into said cell group 2 in order to bring the cell group 2 as quickly as possible to the target charge state.

Preferably, the passive balancing unit 10 is also configured to not introduce any too pronounced charge state imbalance between the different cells during the discharging of the cell group 2 to bring it to the target charge state.

Thus, preferably, if this is requested of it by the management member 4, the passive balancing unit 10 is configured to, if the charge state of the cell group 2 is greater than a target charge state, forcing the discharge of all the cells in said cell group 2 in order to bring the cell group 2 as quickly as possible to the target charge state.

Different algorithms can be implemented in the management member 4 and/or the passive balancing unit 10 to ensure the discharging of the cell group 2 via the passive balancing unit 10 when the power supply device 1 is in the passive balancing mode. For example, at least one implemented algorithm can order a simultaneous discharging of all the cells or at least one implemented algorithm can order a discharging of all the cells by discharging during a given time lapse of each cell alternatively, such that once the given time lapse has passed, the discharging restarts again during the same time lapse (or a different time lapse) in each cell alternatively and so on.

Preferably, whatever the algorithm chosen, the discharging stops at regular intervals to give time to the measuring means 5 to estimate the charge state of the cell group 2 and thus to allow the management member 4 to estimate if the discharge must continue or not. In a variant, the discharging and the estimation of the charge state of the cell group 2 is done simultaneously and/or continuously.

An example of a non-limiting algorithm is given below (by simultaneous discharging between the different cells and temporary stopping of the discharging for the estimation of the charge state):

Start:

While the charge state is greater than the target charge state:
{Closing the circuits in parallel from all the cells during a given time lapse
Measuring the charge state again}

The given time lapse for stopping the discharge is, for example, between 5 and 20 seconds and, for example, between 10 and 15 seconds and is, for example, 10 seconds.

The passive balancing unit 10 therefore has two functions:

in nominal mode, ensuring a balancing of the charge state between the different cells,

in long-duration storage mode, bringing the cell group 2 to the target charge state.

It is retained that the target charge state corresponds to the optimal charge level for the storage of the cell group 2. This target charge state can be provided by the manufacturer of the cell group 2 or by the manufacturer of the power supply device 1 or by the manufacturer of the object associated with the power supply device 1. It can also be predefined according to the nature of the cells of the cell group 2 and the way in which it is sought to manage the cell group 2 (for example, according to the algorithm chosen to discharge the cells). It can be modifiable or not by the user (via, for example, the man-machine interface 6). It can be defined by the user (via, for example, the man-machine interface 6) or be defined and fixed in the factory during the manufacture of the cell group 2 or of the power supply device 1 or of the object. For example, the target charge state is between 25 and 60% and, for example, is between 30 and 50% and is, for example, between 35 and 45%. The target charge state can therefore be, for example, 30 or 35 or 40 or 45%.

Moreover, the long-duration storage is, in this case, associated with at least one first datum. The first datum is the minimum value of a period for which, if the power supply device 1 is not used during this period, it proves preferable to be in long-duration storage mode and not in nominal mode.

The first datum is, in this case, a predefined datum (for example, by the manufacturer of the cell group 2 or by the manufacturer of the power supply device 1 or by the manufacturer of the object associated with the power supply device) according to the nature of the cells of the cell group 2 and the way in which it is sought to manage the cell group 2 (for example, according to the algorithm chosen to discharge the cells).

This first datum is, for example, provided to the user, for example, in the operating instructions of the object associated with the power supply device 1.

The first datum is, for example, of 2 weeks (i.e. if the period during which the power supply device 1 is not used is of at least 2 weeks, it would be preferable to be in long-duration storage mode) and for example, of 1 month (i.e. if the period during which the power supply device 1 is not used is of at least 1 month, it would be preferable to be in long-duration storage mode) and for example, of 3 months (i.e. if the period during which the power supply device 1 is not used is of at least 3 months, it would be preferable to be in long-duration storage mode) and for example, of 6 months (i.e. if the period during which the power supply device 1 is not used is of at least 6 months, it would be preferable to be in long-duration storage mode). Naturally, the user can solely decide to switch into long-duration storage mode even if they ignore for how much time, they will store the power supply device 1.

As will be detailed below, the power supply device 1 which has just been described is configured to manage the charge state of the cell group 2 in order to bring it to the target charge state, and that the charge state of the cell group 2 is located at a level greater than or less than the target charge state.

If the target charge state is greater than the charge state of the cell group 2, the power supply device 1 is configured to recharge the cell group to the target charge state by way of the transmission circuit, of the cut-off member 9 and of the charge means 8.

If the target charge state is less than the charge state of the cell group 2, the power supply device 1 is configured to discharge the cell group 2 to the target charge state by way of the passive balancing unit 10.

In reference to 2, a first example of a particular implementation of the invention will now be described.

According to a first step 101, the user wanting to store their power supply device 1 indicates this to the power supply device 1. To this end, the user transmits a request to move into long-duration storage mode, via the man-machine interface 6, to the management means 3.

Upon receipt of this request, and according to a second step 102, the management member 4 collects from the measuring means 5, the current charge state of the cell group 2.

If the Current Charge State of the Cell Group 2 is Less than the Target Charge State.

During a third step 103, the management member indicates, via the man-machine interface 6, to the user that they must connect the charge means 8 to the power supply device 1. For example, a light of the man-machine interface 6 can flash to indicate that the power supply device 1 must be recharged.

The user thus connects the charge means 8 to the power supply device 1 during a fourth step 104 and the management member 4 closes the transmission circuit to enable the charging of the cell group 2.

Inside the power supply device, the management member 4 monitors the charging of the cell group 2 via the measuring means 5. When the charge state of the cell group 2 reaches the target charge state, during a fifth step 105, the management member opens the transmission circuit to stop the charging of the cell group 2.

Optionally, the management member 4 also indicates, via the man-machine interface 6, to the user that they can disconnect the charge means 8. For example, the light of the man-machine interface 6 which flashed is off and another light of the man-machine interface 6 is on, indicating in the same way to the user that they can disconnect the charge means 8 and store the power supply device 1.

As an option, the user can store the power supply device 1 by leaving the charge means 8 connected to the power supply device 1.

If the Current Charge State of the Cell Group 2 is Less than the Target Charge State.

Optionally, the management member 4 indicates, via the man-machine interface 6, to the user that they can store the power supply device 1. For example, a light of the man-machine interface 6 is on, indicating in the same way to the user that they can store the power supply device 1.

If the Current Charge State of the Cell Group 2 is Less than the Target Charge State.

During a third step 103′, optionally, the management member 4 indicates, via the man-machine interface 6, to the user, that they can store the power supply device 1. For example, a light of the man-machine interface 6 is turned on, indicating in the same way to the user that they can store the power supply device 1.

During a fourth step 104′, the management member 4 orders a discharging of the cell group 2 to the passive balancing unit 10.

Inside the power supply device 1, the management member 4 monitors the discharging of the cell group 2 via the measuring means 5. When the charge state of the cell group 2 reaches the target charge state, during a fifth step, the management member 4 orders the passive balancing unit 10 to stop the discharging.

Return to Nominal Mode

If the user requests a return to nominal mode (for example, in the case where they want to again use the power supply device 1 in nominal mode, i.e. by using the power supply device 1 by opposing the long-duration storage mode where the power supply device 1 is stored), the user thus indicates this to the power supply device 1 during a first phase 111. To this end, the user transmits a return request to the nominal mode, via the man-machine interface 6, to the management means 4.

For example, the user transmits a request to return to the nominal mode, via the connection interface 7, by connecting the charge means 8 to the power supply device 1. In a variant, the request can be, for example, a simple complete charging request of the cell group 2.

The request to return to the nominal mode can therefore be explicit (via the man-machine interface 6) or implicit (via the connection interface 7).

During a second phase, if the charge means 8 are not already connected to the power supply device 1, the management member 4 indicates, via the man-machine interface 6, to the user that they must connect the charge means 8 to the power supply device 1. For example, a light of the man-machine interface 6 can flash to indicate that the power supply device 1 must be recharged.

The user thus connects the charge means 8 to the power supply device 1 (if this is not already done) during a third phase and the management member 4 closes the transmission circuit to enable the charging of the cell group 2.

The power supply device 1 thus switches into its nominal mode until a new request to move into the long-duration storage mode.

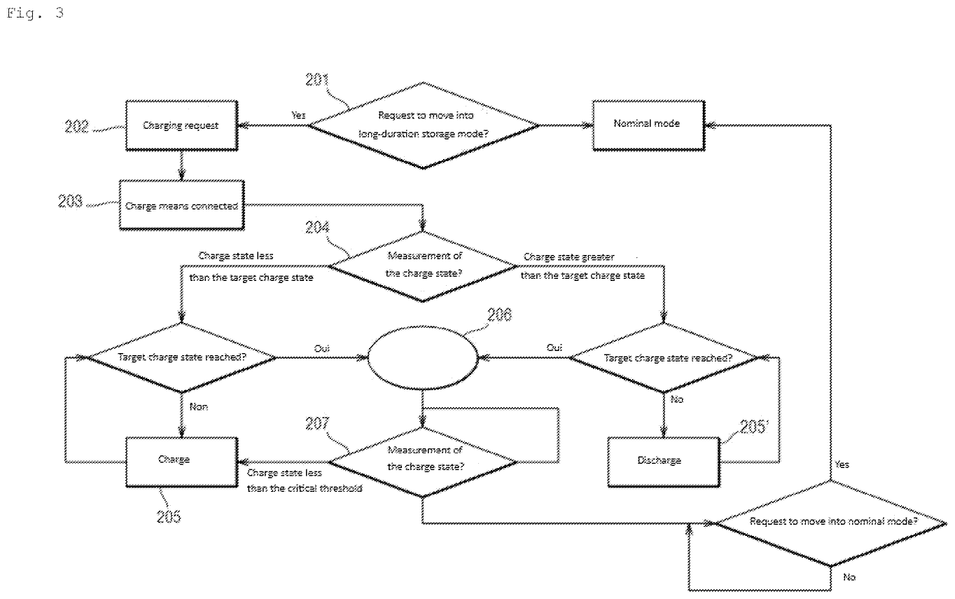

In reference to FIG. 3, a second example of a particular implementation of the invention will now be described.

While in the first example, once the target charge state is reached, the power supply device 1 no longer dealt with the charge state of the cell group 2 before a return to nominal mode, in the second example, the power supply device 1 deals with the charge state of the cell group 2 also in the long-duration storage mode.

Indeed, the cells naturally tend to self-discharge, even if they are not used. The second example makes it possible to overcome this disadvantage, by adding a temporary recharge functionality vis-à-vis the first example of the cell group 2, either until the initial target charge state at the time of moving to the long-duration storage, or until a different increment value of the target charge state at the time of moving to the long-duration storage mode. This increment value can be provided by the manufacturer of the cell group 2 or by the manufacturer of the power supply device 1 or by the manufacturer of the object associated with the power supply device. It can also be predefined according to the nature of the cells of the cell group 2 and the way in which it is sought to manage the cell group 2 (for example, according to the algorithm chosen to discharge the cells). It can be modifiable or not by the user (via, for example, the man-machine interface). It can be defined by the user (via, for example, the man-machine interface) or be defined and fixed in the factory during the manufacture of the cell group 2 or of the power supply device 1 or of the object. For example, the increment value is between 25 and 60% and, for example, is between 30 and 50% and is, for example, between 35 and 45%. The new value can therefore be, for example, 30 or 35 or 40 or 45%. The increment value is preferably less than the initial target charge state at the time of moving to the long-duration storage mode.

In this second example, the charge means 8 must however be connected to the power supply device 1 during the long-duration storage mode (or at least during some of said long-duration storage mode).

According to a first step 201, the user wanting to store their power supply device 1 indicates this to the power supply device 1. To this end, the user transmits a request to move into long-duration storage mode, via the man-machine interface 6, to the management means 3.

Upon receipt of this request, and according to a second step 202, the management member 4 indicates, via the man-machine interface 6, to the user that they must connect the charge means 8 to the power supply device 1. For example, a light of the man-machine interface 6 can flash to indicate that the power supply device 1 must be connected to the charge means 8.

The user thus connects the charge means 8 to the power supply device 1 during a third step 203.

Once the management member 4 detects that the charge means 8 are connected, and according to a fourth step 204, the management member 4 collects measuring means 5 for the current charge state of the cell group 2. This fourth step 204 can be automatically follow on from the detection of the connection of the charge means 8 or can only be implemented in case of action of the user, for example on the man-machine interface 6 (for example, the user must validate that the charge means 8 are connected to the power supply device 1 such that this fourth step 204 is implemented).

Optionally, the management member 4 indicates, via the man-machine interface 6, to the user that they can store the power supply device 1 connected to the charge means 8.

At the start-up of the long-duration storage mode

If the Current Charge State of the Cell Group 2 is Less than the Target Charge State.

During a fifth step 205, the management member 4 closes the transmission circuit to enable the charging of the cell group 2.

Inside the power supply device 1, the management member 4 monitors the charging of the cell group 2 via the measuring means 5. When the charge state of the cell group 2 reaches the target charge state, during a sixth step 206, the management member 4 opens the transmission circuit to stop the charging of the cell group 2.

If the Current Charge State of the Cell Group 2 is Less than the Target Charge State.

No additional step is implemented.

If the Current Charge State of the Cell Group 2 is Less than the Target Charge State.

During a fifth step 205′, the management member 4 orders a discharging of the cell group 2 to the passive balancing unit 10.

Inside the power supply device 1, the management member 4 monitors the discharging of the cell group 2 via the measuring means 5. When the charge state of the cell group 2 reaches the target charge state, during a sixth step 206, the management member 4 orders the passive balancing unit 10 to stop the discharging.

During the Long-Duration Storage Mode

According to a seventh step 207, the management member 4 periodically collects measuring means 5 for the current charge state of the cell group 2.

For example, the management member 4 collects measuring means 5 for the current charge state of the cell group 2 at least once a week and preferably at least once a day. Preferably, the management member 4 collects means for measuring 5 the current charge state of the cell group 2 one single time a day.

If the charge state falls below a charge state critical threshold, the management member 4 closes the transmission circuit to enable the charging of the cell group 2.

The critical threshold can be provided by the manufacturer of the cell group 2 or by the manufacturer of the power supply device 1 or by the manufacturer of the object associated with the power supply device. It can also be predefined according to the nature of the cells of the cell group 2 and the way in which it is sought to manage the cell group 2 (for example, according to the algorithm chosen to discharge the cells). It can be modifiable or not by the user (via, for example the man-machine interface 6). It can be defined by the user (via, for example the man-machine interface 6) or be defined and fixed in the factory during the manufacture of the cell group 2 or of the power supply device 1 or of the object. For example, the critical threshold is between 5 and 30% and for example, is between 10 and 20%. The critical threshold can therefore be, for example 10, 15 or 20%. In a variant, the critical threshold is equal to the target charge state of the start of the long-duration storage mode.

Inside the power supply device 1, the management member 4 monitors the charging of the cell group 2 via the measuring means 5. When the charge state of the cell group 2 again reaches the target charge state of the start of the long-duration storage mode (or the increment threshold described above), the management member 4 opens the transmission circuit to stop the charging of the cell group 2.

Then, the seventh step of monitoring 207 the charge state of the cell group 2 is returned to.

Return to Nominal Mode Return to Nominal Mode

If the user requests a return to nominal mode (for example, in the case where they want to again use the power supply device 1 in nominal mode, i.e. by using the power supply device 1 by opposing the long-duration storage mode where the power supply device 1 is stored), the user thus indicates this to the power supply device 1 during a first phase 211. To this end, the user transmits a request to return to nominal mode, via the man-machine interface 6, to the management means 3. This request can be, for example a simple request to completely charge the cell group 2. In a variant, the user transmits a request to return to nominal mode, via the connection interface 7, by disconnecting the charge means 8 of the power supply device 1. The request to return to nominal mode can therefore be explicit (via the man-machine interface 6) or implicit (via the connection interface 7).

During a second phase, if the charge means 8 are always connected to the power supply device 1, the management member 4 closes the transmission circuit to enable the charging of the cell group 2.

The power supply device 1 thus switches into its nominal mode until a new request to move into the long-duration storage mode.

Whatever the example of implementation described, it is noted that the power supply device 1 is configured such that if the target charge state is less than the charge state of the cell group 2, the passive balancing unit 10 is used to bring, as quickly as possible, said cell group 2 to the target charge state. Thus, the passive balancing unit 10 does not work traditionally to reach a balance between the cells, but to make the target charge state to be reached by the cell group 2. However, if the target charge state is greater than the charge state of the cell group 2, the power supply device 1 is configured to control a charging of the cell group 2 until the target charge state.

Thus, the power supply device 1 described makes it possible to manage the charge level of the cells, the charge state of the cell group 2 being in a level greater than or less than the target charge state.

The power supply device 1 is therefore configured to enable a charging or a discharging until the target charge state.

This simply makes it possible to protect the cells, and thus preserve their service life.

Advantageously, the power supply device 1 is sufficient to order the charge or the discharge of the cell group 2 and therefore does not require the external element (outside of the charge means 8 which are, in any case, already necessary to charge the power supply device in nominal mode).

Moreover, it is noted that the examples which have been described are implemented by the electronic board and in particular by the management member 4.

Naturally, the invention is not limited to the embodiments described, and variants may be provided without going beyond the scope of the invention such as defined by the claims.

Thus, although in this case, the power supply device is connected to an electric bike, the device can be connected to any other vehicle like an electric scooter, a handling machine, etc., or can be connected to any object other than a vehicle requiring a power supply device, like for example, a laptop, etc.

Although, in this case, the cells are Lithium batteries, the cells can be any other type of rechargeable batteries.

Although, in this case, the management means comprise a Battery Management System, the management means can comprise other elements (alternatively or complementarily). Thus, in a variant, the management means can comprise a single electronic board equipped with a management member and making it possible to ensure a passive balancing of the cells.

Although, in this case, this is always the user who controls moving into long-duration storage mode, the moving to the long-duration storage mode can be requested directly by the management means without intervention from the user (and that the device comprises, or not, a man-machine interface and/or is in communication or not with a man-machine interface).

For example, if the user leaves connecting the charge means to the power supply device, and that during a given time delta, the management member has recorded no request from the user to switch into the long-duration storage mode, the management member can automatically make the power supply device switch into the long-duration storage mode (for example, according to one of the abovementioned examples or a combination of both).

Optionally, if the user has not left connecting the charge means to the power supply device, and that during a given time delta, the management member has recorded no request from the user to switch into the long-duration storage mode, the management member can automatically make the power supply device switch into the long-duration storage mode (according to the degraded mode, wherein it can only discharge the cell group to bring it to the target charge state).

In both cases (charger connected or not to the power supply device), the time delta for automatically move into long-duration storage mode can be provided by the manufacturer of the power supply device or of the associated object. It can also be predefined according to the nature of the cells of the cell group and the way in which it is sought to manage the cell group (for example, according to the algorithm chosen to discharge the cells). It can be modifiable or not by the user (via, for example the man-machine interface). It can be defined by the user (via, for example the man-machine interface) or be defined and fixed in the factory during the manufacture of the power supply device or of the object. For example, this time delta is of at least two weeks and preferably of at least one month. This time delta is, for example of one month.

The request to return to the nominal mode can be required directly by the management means without intervention of the user (and that the device comprises, or not, a man-machine interface and/or is in communication, or not, with a man-machine interface) or can be required by the user (implicitly or explicitly).

The power supply device can urge the user during a request to move into the long-duration storage mode or cannot urge the user (and that the device comprises, or not, a man-machine interface and/or is in communication, or not, with a man-machine interface).

Instead of the man-machine interface being integrated with the power supply device as has been indicated, the power supply device can be configured to communicate with a man-machine interface remote from the power supply device. The man-machine interface can be integrated with the object associated with the power supply device without being integrated with the power supply device (for example, the man-machine interface can be integrated with a general control panel of the object) or can also be remote from the object itself. The man-machine interface can thus be a computer, a so-called “smart” mobile phone (more known under the term, “smartphone”), etc. The power supply device can thus exchange with the user via an app present on the smartphone of the user. Naturally, the power supply device can both integrate a man-machine interface and be configured to communicate with a man-machine interface remote from the power supply device. Naturally, the object can both integrate a man-machine interface and be configured to communicate with a man-machine interface remote from the object. To communicate with a man-machine interface remote from the power supply device and/or from the object, the power supply device and/or the object can comprise a communication interface externally (via a wired connection, a Bluetooth (trademark) connection, a Wi-Fi connection, etc.).

Although, in this case, it has always been a question about a target charge state, the power supply device can be configured such that the cell group reaches a target charge state range. For example, the range can be centred around an abovementioned value (like, for example, 25 or 30 or 35%). For example, the range can be of more or less 10% or also more or less 5% around one of the abovementioned values. For example, the range can be [35%; 45%]. Consequently, if the cell group has a charge state already in the target charge state range, the power supply device can be configured to not further discharge the cell group or can be configured to further discharge the cell group, such that its charge state is centred or further centred on said target charge state range.

Moreover, although in this case, the power supply device enables the charging, as it does the discharging, of the cells during switching into the long-duration storage mode, in a degraded mode, the power supply device can only be configured to only enable a discharging of the cells during the switching into the long-duration storage mode.

Once the target charge state is reached, following the charging of the cell group, the user can be brought to disconnect the charge means or can be brought to leave them in place.

The power supply device can indicate, or not, to the user, at which stage the power supply device is found (during charging, during discharging, during convergence to the target charge state, if the target charge state is reached, etc.). This can be done, for example, via a man-machine interface.

Although, in this case, the long-duration storage is associated with one single datum, the long-duration storage can be associated with at least one second datum.

The second datum can be the maximum value of the period for which, if the power supply device 1 is not used during this period and is found in the long-duration storage mode, it proves to be necessary to exit from said long-duration storage mode, i.e. the second datum will indicate the maximum time lapse at the end of which the long-duration storage mode must be exited from (with the aim of recharging the cell group), either by moving back to nominal mode, or by switching into a new long-duration storage mode, as will be explained below. Indeed, as the cells naturally tend to self-discharge, the charge state of the cells will tend to lower during the long-duration storage. If this charge state becomes too low, this could lead to irreversible modifications of the features of the cells. It is therefore preferable to ensure that the long-duration storage mode is not stayed in for too long, or at least, that the long-duration storage mode is not stayed in for too long without recharging the cell group. The second datum can thus be a predefined datum (for example, by the manufacturer of the cell group or by the manufacturer of the power supply device or by the manufacturer of the object associated with the power supply device) according to the nature of the cells of the cell group and the way in which it is sought to manage the cell group (for example, according to the algorithm chosen to discharge the cells). For example, the second datum is provided to the user, for example in the operating instructions of the object associated with the power supply device. The second datum will be, for example, of 10 months and for example, of 1 year and, for example, of 18 months. Naturally, the user can also solely decide to exit from the long-duration storage mode, even if it has not reached the second datum. Alternatively, the second datum could not be a time value, but for example a minimum charge state value (and for example, the value of the critical threshold).

In the case of the first embodiment, in view of the second datum which has been provided to them, the user will thus request a return to nominal mode, no longer because they will want to again use the power supply device in nominal mode, but because they will want to exit from the long-duration storage mode to recharge the cell group and avoid them being damaged. However, the return to nominal mode will be done according to the same steps, which has already been described for the first embodiment (only the reason changes). Moreover, once the battery unit is at least partially recharged (preferably once the battery unit having at least reached the target charge state or the target charge state range), the user can again request the switching into long-duration storage mode.

In the case of the second embodiment, advantageously, the user will not need to be interested in the second datum (which can optionally not be provided to them, even which cannot be predefined), since the charge state of the cell group during the long-duration storage mode will be monitored by the power supply device itself.

Moreover, although in this case, this is always a return to nominal mode which makes the power supply device exit from its long-duration storage mode, this can be done differently. Thus, this can also be a new request for long-duration storage which makes the power supply device exit from its first long-duration storage mode. Indeed, if the user ultimately wants to store their power supply device for longer than planned and/or if the user knows the second abovementioned datum, they can request, once again, to move into the long-duration storage mode (which will thus be the second long-duration storage mode), which will advantageously make it possible to recharge at least partially, the cell group. One of the abovementioned examples or a mixture of both can thus be the basis for this new second long-duration storage mode. In any case, if it is sought to recharge the cell group upon exiting a long-duration storage mode, this recharging can only be partial, in particular if it is not sought to use the power supply device in the nominal mode, but to go back into a new long-duration storage mode.

The value of the critical threshold can be different or identical between two occurrences of charging during one same long-duration storage mode or between two different movements into long-duration storage mode.

The value of the increment threshold can be different or identical between two occurrences of charging during one same long-duration storage mode or between two different movements into long-duration storage mode.

The value of the target charge state can be different or identical between two occurrences of charging during one same long-duration storage mode or between two different movements into long-duration storage mode.

The long-duration storage can be associated only with the second datum (the maximum value of the period for which, if the power supply device is not used during this period and is found in the long-duration storage mode, it proves to be necessary to exit from said long-duration storage mode) and not to the first datum (the minimum value of a period for which, if the power supply device is not used during this period, it proves to be preferable to be in long-duration storage mode and not in nominal mode). The two examples of implementation described can naturally be combined together.

The cell group can only comprise one single cell, the passive balancing unit thus only fulfilling its function of bringing, if needed, the cell group to the target charge state (and therefore not performing balancing). The cell group can alternatively comprise at least two cells, such that the passive balancing unit thus fulfils its two balancing functions of the charge state between the different cells and to bring, if needed, the cell group to the target charge state.

The passive balancing unit can be integrated with the management member.

The measuring means can be integrated with the management member or with the passive balancing unit.

The passive balancing unit can only stop the forced discharging of the cells, such that the cell group reaches the target charge state, without intervention of the management member.

1. A power supply device comprising:
a group of at least one power supply cell,
means for managing the cell group comprising a passive balancing unit of said cells, the device wherein, during a request to move into long-duration storage mode of the device, the management means are configured to, via the passive balancing unit, discharge the cell group until the cell group reaches a target charge state or a target charge state range, if a charge state of the cell group is greater than the target charge state or the target charge state range.

2. The device according to claim 1, wherein the management means comprise a Battery Management System.

3. The device according to claim 1, comprising a man-machine interface or being connected to a man-machine interface.

4. The device according to claim 3, configured to receive the request to move into long-duration storage mode via the man-machine interface.

5. The use of a device according to claim 1, for supply power to an electric vehicle.

6. The use of a device according to claim 5, wherein the electric vehicle is an electric bike.

7. The method for managing a power supply device according to claim 1, comprising the step of, during a request to move into long-duration storage mode of the device, and if a charge state of the cell group is greater than the target charge state or the target charge state range, discharging the cell group until the cell group reaches the target charge state or the target charge state range.

8. The method according to claim 7, comprising the step, in the long-duration storage mode, of charging the cell group if a charge state of said cell group falls under a predetermined critical threshold.

9. The computer program comprising instructions which cause the device according to claim 1 to execute the step of, during a request to move into long-duration storage mode of the device, and if a charge state of the cell group is greater than the target charge state or the target charge state range, discharging the cell group until the cell group reaches the target charge state or the target charge state range.

10. The storage medium which can be read by a computer, on which the computer program according to claim 9 is recorded.
